(19) United States
(12) Patent Application Publication
(10) Pub. No.: US 2004/0050974 A1
(43) Pub. Date: Mar. 18, 2004

(54) Valve-encased nozzle device and liquid handling device

(76) Inventors: Chahn Lee, Hitachinaka (JP); Kiyomi Yoshinari, Hitachi (JP); Kinya Kobayashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/636,655

(22) Filed: Aug. 8, 2003

(30) Foreign Application Priority Data
Aug. 26, 2002 (JP) 2002-245313

(51) Int. Cl. B05B 1/32

(52) U.S. Cl. 239/537; 239/583; 347/47; 239/75

(57) ABSTRACT

A valve encased nozzle device comprising a valve chamber having an introduction port for introducing pressurized liquid, and an opening for injecting the liquid, and a valve for closing and opening one or both of the introduction port and the injecting port, wherein the valve is disposed together with a valve driving mechanism in the valve chamber, whereby the introduction port or the injecting port or both are closed or opened by movement of the valve driven by the driving mechanism.

### DESCRIPTION OF THE INVENTION

1. Field of the Invention

The present invention relates to a nozzle device having a valve disposed in a valve chamber and a liquid handling device using the nozzle device. The valve device of the present invention is particularly useful for pipetting devices or micro pipetting devices in biotechnology, inkjet printers, etc that need to supply a small and precise volume of liquid.

2. Description of Prior Art

Micro volumes of liquid that is used in various industry range from 5 pico-litters in inkjet printers to 250 micro-litters in micro-pipettes. There are different types of nozzle devices each having a specific structure, based upon the purpose of use. The fundamental requisites for the nozzle devices are: (1) a constant injection pressure and (2) round liquid drops and its high reproducibility.

As liquid has its own physical properties such as surface tension, viscosity, etc, kinds of liquid are necessarily limited. For example, in inkjet printers that utilize piezo transducers or vapor pressure of liquid bubbles generated by heating liquid having a viscosity of about 1 to 3 mPs·sec, which is close to that of water is chosen so as to meet the above-mentioned requisites. According to the structure of the nozzle, an amount of liquid per one jet is limited to 5 to 100 pico-litters.

On the other hand, in the fields of paints or printing inks, Japanese Patent Laid-open 11-138791 (1999) discloses in FIG. 4 that a shutter plate is disposed in parallel with an outlet and the shutter is driven by a piezo element. In this type of nozzle devices, there is a fear that leakage of liquid may occur as a liquid pressure increases. Thus, as the pressure becomes higher, the structure should be sturdy. On the other hand, since high shutter speed is required in this technology, it is not easy to meet the above-mentioned conflicting requirements.

The shutter starts to move from one side of the nozzle entrance until the entrance is fully opened or closed. The higher the viscosity, the larger the stress to the edge of the shutter is imparted in opening or closing of the shutter. As a result, the shutter may be deformed, which leads to leakage of liquid, and dispersion of jetting direction. The structure of this type may have a problem of blur of liquid on the nozzle area.

### SUMMARY OF THE INVENTION

If is an object of the present invention to meet the above-mentioned fundamental requirements.

It is another object to provide a nozzle and nozzle device that can suppress an error in volume of liquid drops.

It is a further object of the present invention to provide a nozzle or nozzle device that can jet liquid having a wide range of viscosity and surface tension or non-Newtonian liquid (liquid that changes volume under pressure) to fly as drops with certainty.

The present invention is featured by a nozzle device comprising a valve disposed in a valve chamber and a valve driving mechanism, wherein the mechanism performs its function within the valve chamber. In other words, the valve driving mechanism has no moving element extended from the valve chamber, so that complete liquid tight sealing of the chamber is attained. The present invention also provides a liquid handling device using the nozzle device.

One of the typical applications of the present invention is a liquid handling device, which comprises a nozzle device comprising a valve chamber having a liquid introduction port, which is connectable to a liquid source, and a liquid jetting port, a valve, confined in the valve chamber, for closing and opening the introduction port and/or the jetting port, and a valve driving mechanism, confined in the valve chamber, wherein the valve and the valve driving mechanism complete their functions in the valve chamber.

Another typical application is an inkjet head, which comprises an array of nozzle devices each comprising a valve chamber having an ink introduction port and a nozzle for an ink jetting port, a valve, confined in the valve chamber, and a valve driving mechanism, confined in the valve chamber, for driving the valve, wherein the valve and the valve driving mechanism are liquid tightly sealed in the valve chamber and the valve and the valve driving mechanism perform their functions only in the valve chamber.

Still another typical application of the present invention is an inkjet printer, which comprises an array of nozzle devices each comprising a valve chamber having an ink introduction port, which is connectable to an ink source, and an ink jetting port, a valve, confined in the valve chamber, for closing and opening the ink introduction port and/or the ink jetting port, and a valve driving mechanism, confined in the valve chamber, wherein the valve and the valve driving mechanism complete their functions in the valve chamber.

Further, another typical application of the present invention is an inkjet printer, which comprises an inkjet head comprising an array of nozzle devices, wherein each of the nozzle devices comprises a valve chamber having an ink introduction port and a nozzle for an ink jetting port, a valve, confined in the valve chamber, and a valve driving mechanism, confined in the valve chamber, for driving the valve, wherein the valve and the valve driving mechanism are liquid tightly sealed in the valve chamber and the valve and the valve driving mechanism perform their functions only in the valve chamber; a controller for controlling the inkjet head; and a recording medium transfer mechanism.

A still another typical application of the present invention is a micro-pipetting device for supplying liquid in a micro amount, which comprises a micro-titer plate for receiving liquid samples and a nozzle device, wherein the nozzle device comprises a valve chamber having a liquid introduction port and a liquid jetting port, a valve for closing and opening the introduction port and the jetting port, and a valve driving mechanism, the vale and the valve driving mechanism being confined within the valve chamber.

### BRIEF DESCRIPTION OF DRAWINGS

FIG. 1a is a side elevational sectional view of a valve encased nozzle of the first embodiment of the present invention.

FIG. 1b is a sectional view along the b-b line in FIG. 1a.

FIG. 1c is a perspective, partially broken-away of the valve encased nozzle shown in FIGS. 1a and 1b.

FIG. 2a shows shifts of a valve with respect to time.

FIG. 2b shows pressure change at the opening port.

FIG. 3 is a side elevational sectional view of the valve encased nozzle of another embodiment.

FIG. 4 shows a side elevational sectional view of the valve encased nozzle of another embodiment.

FIG. 5 further shows a side elevational sectional view of the valve encased nozzle of another embodiment.

FIG. 6 further shows a side elevational sectional view of the valve encased nozzle of another embodiment according to the present invention.

FIG. 7 is a sectional view along the line b-b of FIG. 6.

FIG. 8 is a side elevational sectional view of the valve encased nozzle of another embodiment, which is equipped with a pressure maintaining mechanism at the opening port.

FIG. 9 is a diagrammatic drawing of a nozzle device that utilizes the valve encased nozzle shown in FIG. 8.

FIG. 10 is a graph showing relationship between pressure change at a pressure section with respect to time and closing and opening time of the valve.

FIG. 11 is a diagrammatical top plane view of an inkjet head of an embodiment according to the present invention.

FIG. 12 is another top view of an inkjet head of another embodiment of an inkjet printer according to the present invention.

FIG. 13 is a diagrammatical drawing of an inkjet printer of the present invention.

### DETAILED DESCRIPTION OF PREFERRED EMBODIMENTS

The nozzle device of the present invention comprises a valve chamber having an introduction port for pressurized liquid and an opening port for jetting the pressurized liquid, a valve for closing and opening the introduction port or the opening port or both, and a valve driving mechanism. The valve is encased in the valve chamber together with a valve driving mechanism. The valve moves upon the operation of the driving mechanism to close or open the introduction port or the opening port or both.

The nozzle device according to the present invention comprises the above-mentioned valve encased nozzle, a liquid supply section and a pressure section to impart jetting pressure to the liquid to be jetted.

According to the present invention, the nozzle device in which a valve is encased in the valve chamber together with the valve driving mechanism and the valve is driven by the driving mechanism in the valve chamber can jet various kinds of liquids having different physical properties at desired volumes and desired speeds as drops.

Since the valve and the valve driving mechanism are encased in the valve chamber, and since an appropriate pressure is applied to every portion of the components, an excess stress is not imparted on the valve and leakage of liquid and deformation of the valve are avoided.

The valve can not only open and close the introduction port and opening port, but can positively impart pressure change on the liquid to be jetted at the time of opening; it is possible to make independent drops from string form liquid so that accuracy of measurement of volume of the drops is increased.

Various types of valve driving mechanisms can be employed as far as it moves the valve against pressure in the valve chamber. For example, there is a mechanism that drives the valve by magneto-motive force, a tunnel motor, a linear motor, a mechanism that drives a magnet valve by electric magnet, or a piezo (voltage) element. The valve is driven by bubbles generated by heating the liquid in the valve chamber.

One aspect of the present invention resides in that the shapes of the introduction port or the opening port or both formed in the valve chamber and the shape of the valve are axially symmetric, and that the center line is located on the same axis. The introduction port and the opening are closed or opened by movement in the direction of the center line of the valve. In this aspect, there is an advantage that liquid drops from the opening port are injected in the center line without dispersing. The valve can be a slide valve. In this case, a stable jetting of liquid drops can be expected when the distance of the opening port is extended.

The valve can be disposed only at the introduction port of the pressurized liquid. A single valve can open and close both of the introduction port and the opening port at the same time. In this case, the single valve is preferably one that works for the introduction port as a slide valve, and works for the opening port as moves in the direction of the center line. The valve is adequately selected from the view points of a pressure in the valve chamber, a stress to the valve, the degree of a driving force, the size of the opening port, etc.

As another aspect, the shape of the opening port can be changeable. For example, when an opening port having a long distance is used, turbulent flow of liquid can be injected in the streamlined form. When a diameter of the opening port is altered, volumes of liquid drops can be changed.

As a further aspect, the nozzle device further comprises a mechanism for maintaining a predetermined pressure in the opening port at the time of opening and closing the valve, the pressure maintaining mechanism being connected to a negative pressure source. As a result, the surface of the liquid in the opening port is surely maintained as Meniscus surface, thereby to prevent liquid leakage and instability of liquid jetting.

In a further aspect, the nozzle device further comprises a mechanism for maintaining a predetermined pressure in the valve chamber, the maintaining mechanism being connected to a negative pressure source. In this aspect, if the liquid pressure supplied to the valve chamber is high, liquid leakage and instability of liquid surface are avoided and stable liquid injection is reproducible and surely, when the pressure in the valve chamber is set as an intermediate between the supplying pressure of liquid and the atmosphere.

A pressure generated by a pressure section for imparting injection pressure to the jetted liquid is a constant pressure, a pulsating pressure, or a tome depending changing pressure. The pulsating pressure or the time depending changing pressure are better than the constant pressure, because the load to the valve can be relieved and a stable liquid drops are obtained.

In the following, several embodiments will be explained in detail by reference to drawings.

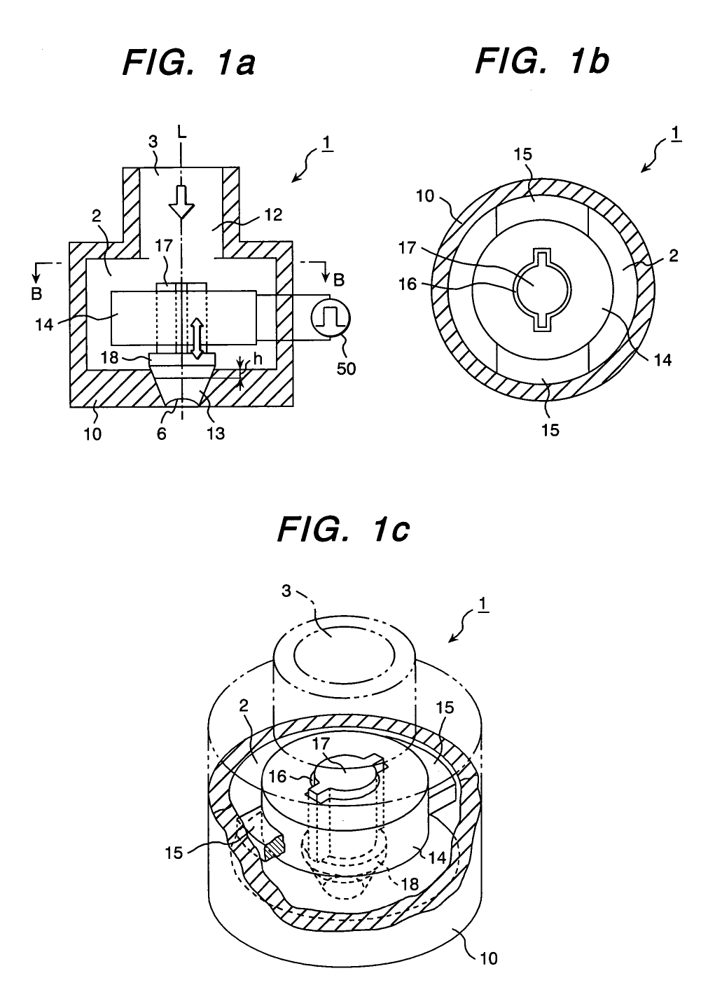

FIG. 1a is a side elevational sectional view of a first embodiment of the valve encased nozzle of the present invention, and FIG. 1b is a sectional view along the line b-b in FIG. 1a. FIG. 1c is a partially broken-away perspective view of the valve-encased nozzle shown in FIGS. 1a and 1b.

In this valve-encased nozzle 1, numeral 10 is a cylindrical casing for defining a valve chamber 2. The casing has an introduction port 12 pressurized by a pressure section (not shown) at the top of the face, and has an opening port 13 at the bottom thereof. The shape of the introduction port 12 is circular, and the shape of the opening port 13 is conical, the lower part being smaller in diameter. The opening and introduction ports have the common center line L.

Liquid pressurized by a pressure section to a desired pressure is supplied to the introduction port through a conduit 3. Then, the liquid flows into the valve chamber 2.

A cylindrical electric magnet 14 is fixedly disposed by a supporting member 15 in the valve chamber 2 in such a manner that the center line of the magnet is commonly aligned with the line L. A magnet valve 17 slidable in the vertical direction is inserted into the center bore 16, the center line of the magnet 17 being commonly aligned with the center line L.

The lower end 18 of the magnet valve 17 has a conical shape such that the opening port 13 is liquid tightly closed.

The electric magnet 14 is supplied with ON-OFF electric signals 50 through a control section to move the magnet valve 17 up and down. In this embodiment, when OFF signal is given, the magnet valve 17 is located at the lowest position to close the valve, and when ON signal is given, the magnet valve 17 is located at the upper position to open the valve.

When the valve is open, pressurized liquid is injected as liquid drops along the center line L into atmosphere by its pressure through the valve chamber 2 to the opening port 13. When a signal OFF is given, the valve is closed to end injection. The electric magnet 14 constitutes the valve driving mechanism in the present invention.

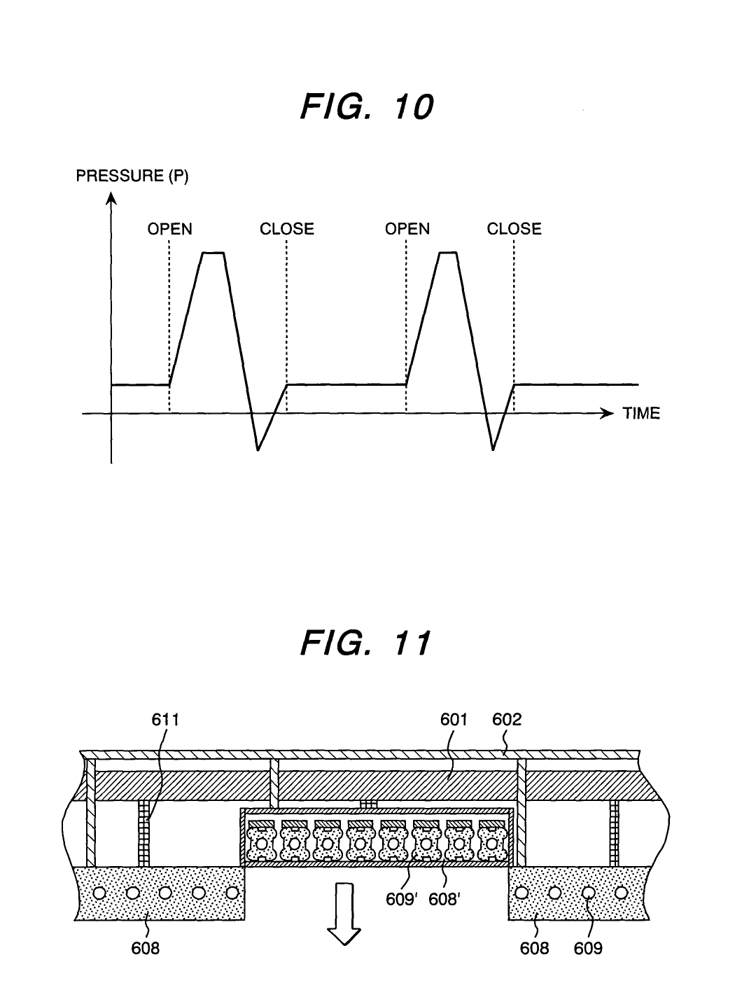

Though in the above embodiment the introduction port 12 is formed at the upper part of the casing 10, it can be formed at the side wall of the casing as shown in FIGS. 10 and 11. In this case, however, there may be a fear that turbulent flow occurs or a pressure gradient occurs in the face at the opening port, since the direction of introduction of liquid differs from that of injection. Thus, it is desired to make the opening port 13 longer thereby to streamline the liquid and to normalize the pressure at the liquid face.

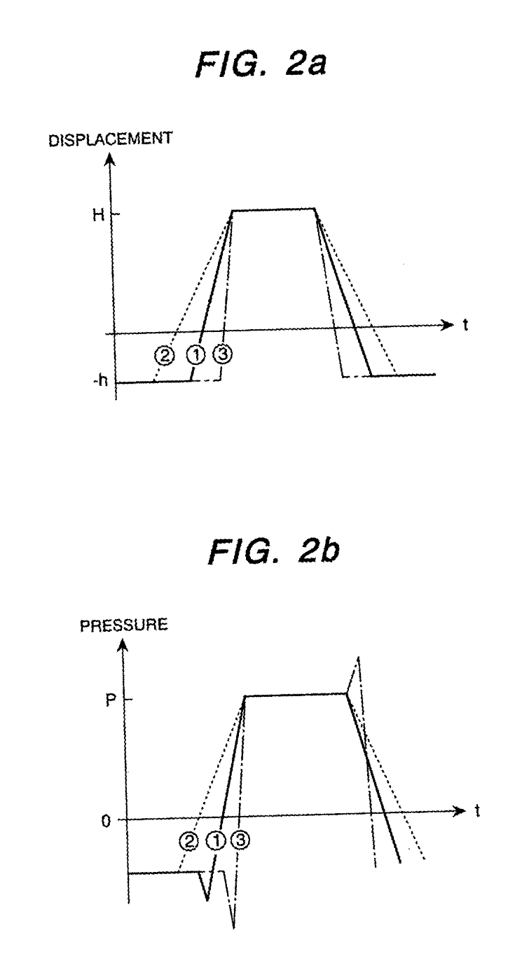

Valve movement, a pressure applied to the opening port and liquid drop injection in the valve encased nozzle shown in FIGS. 1(a), 1(b) and 2 will be explained.

FIG. 2a is a graph showing relationship between time and the positions of the valve where stopping points of the valve is −h. Bias H represents the position where there is no flow resistance to the opening port because of viscosity of the liquid. FIG. 2a shows three rates (1), (2) and (3) of opening speed of the valve. FIG. 2b shows pressure changes as (1), (2) and (3) that occur due to changes of the vale movement.

As shown in FIGS. 2a, 2b, when the opening and closing speeds change, the opening port is given not only the constant pressure P and the initial pressure, but freedom of pressure change. In FIG. 2b, the reason why the initial pressure is negative is that the liquid face has a Meniscus form 6 as shown in FIGS. 1a, 1b and 1c.

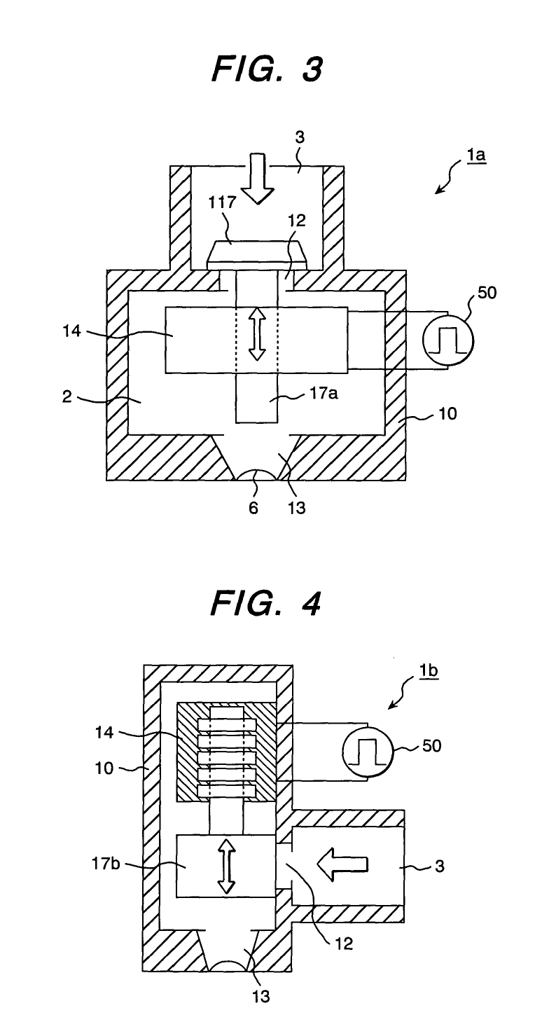

FIG. 3 shows a sectional view of a valve encased nozzle of another embodiment. In the valve encased nozzle 1a, the magnet valve 17a has at its upper position an enlarged diametric portion 117, and the enlarged portion 117 closes the introduction port 12 formed at the top of the casing 10 to stop the flowing of liquid into the valve chamber 2. This is a point different from the embodiment shown in FIGS. 1a, 1b and 1c. The opening port 13 is always open, and it is never closed by the magnet valve 17a.

The magnet valve 17a that is pressed down by liquid pressure normally closes the introduction port 12. The magnet valve 17a is pressed up in response to a signal to the electric magnet 14 to open the introduction port 12 thereby to make the valve open. As a result, the pressurized liquid flows into the valve chamber 2 and the same volume of the liquid is injected to the atmosphere through the opening port 13.

When the signal turns into OFF, the introduction port 12 is closed to make the valve close. Since a closing allowance of the valve can be made large, leakage of liquid is suppressed, and at the same time, the load of operating the valve can be made small.

FIG. 4 is a sectional view of the valve encased nozzle of another embodiment. The valve encased nozzle 1b has the introduction port 12 disposed to the side wall of the casing 10. The valve 17b works as a slide valve with respect to the introduction valve to open and close the introduction port. This is the point different from the ones, especially one shown in FIG. 3.

The electric magnet 14 is of a multi-stack type linear motor, and its function is the same as one shown in FIG. 3. In this embodiment, since the pressure at the introduction port 12 does not directly affect the function of the valve 17b, the driving force for the valve can be made small.

Though it is not shown in FIG. 4, the opening port 13 side can be used as an introduction port, and the introduction port 12 side can be used as a liquid-injection port.

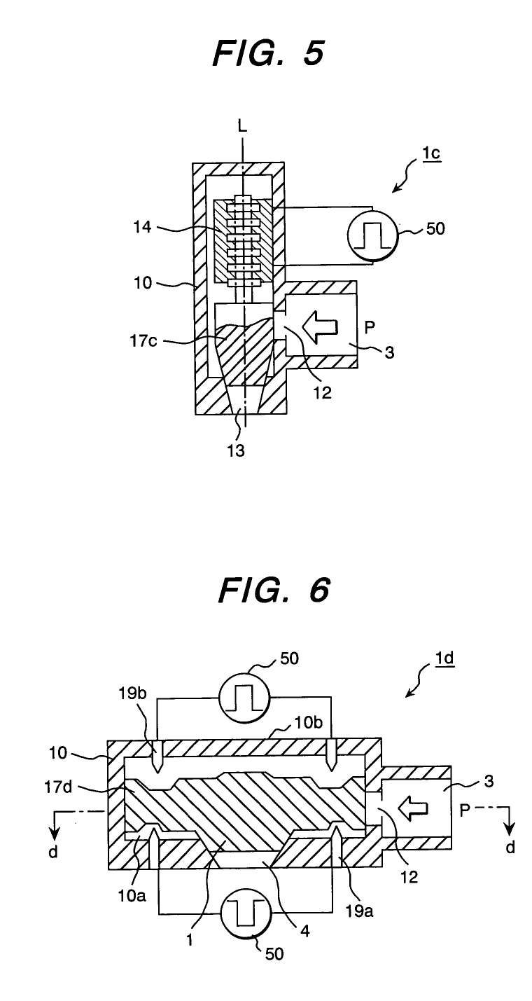

FIG. 5 is a sectional view of a further embodiment of a valve-encased nozzle of the present invention.

In the valve-encased nozzle 1c, the single valve 17c functions as a slide valve with respect to the introduction port, as shown in FIG. 4, and with respect to the opening 12, the valve 17c moves in the direction of the center line L as shown in FIGS. 1a, 1b and 1c to open and close the opening port 13.

If the difference in pressure between pressure P from the pressure source and the atmosphere (normally I ata.) is too large, it may be difficult to prevent leakage of liquid by the valve function of the opening port 13 or of the introduction port 12. In the above-mentioned embodiment, however, since both of the introduction port 12 and the opening port 13 have a valve function, liquid leakage can effectively be prevented.

FIG. 6 is a sectional view of a further embodiment of the valve-encased nozzle of the present invention.

In this valve encased nozzle 1d, a valve 17d is inserted into the casing 10 so as to be able to slide up and down in the casing. A first heater 19a is disposed between the lower face and the bottom face of the casing 10, and a second heater 19b is disposed between the upper face of the valve 17d and the top inner face of the casing 10. ON-OFF control signals are given by a control unit (not shown) to each of the heaters 19a, 19b. When the signal is given, one of the heaters is ON. Heated liquid is boiled to generate bubbles. Using the pressure of the bubbles, the valve 17d is operated. When the ON-OFF state of the first heater 19a and heater 19b are switched, the valve 17d moves up and down to open the opening port 13 thereby to inject liquid.

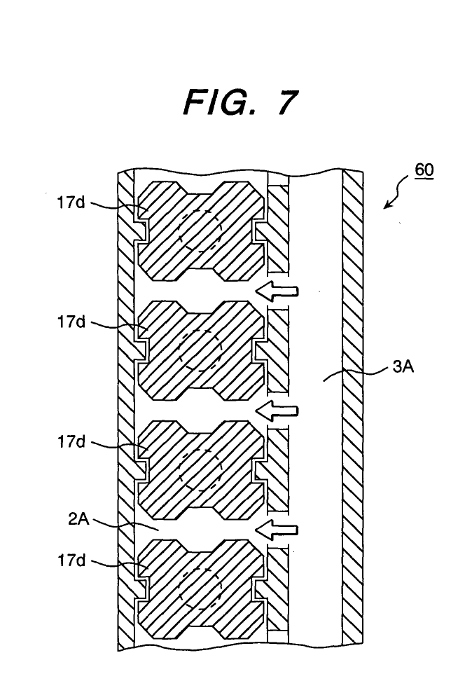

FIG. 7 shows a sectional view of a printer head using a plurality of the valve-encased nozzles shown in FIG. 6. FIG. 7 is a sectional view along the line VII-VII in FIG. 6. A valve chamber 2A and a liquid (ink) supply conduit 3A are common to all of the valve-encased nozzles. Ink pressurized by a single pressure source is supplied to the ink supply conduit 3A, and its own pressure injects the ink.

That is, in this inkjet printer head 60, a pressure device such as a Piezo element for impart high injection energy to each of the nozzles is not necessary, but it is possible to inject ink when a pressure is applied to the ink supply conduit 3A side. This means that it is enough that the motion quantity of the bubbles satisfies the load for open and close operation of the nozzles. The printer head of this invention enables the ink to be injected at higher printing cycles, compared with the conventional printer heads.

The printer head according to the present invention eliminates cross-talk phenomenon that was observed in the conventional printer heads wherein adjoining nozzles give influence of pressure on the adjoining nozzle to generate different volumes of liquid drops at different speeds than the case where a single nozzle injects liquid.

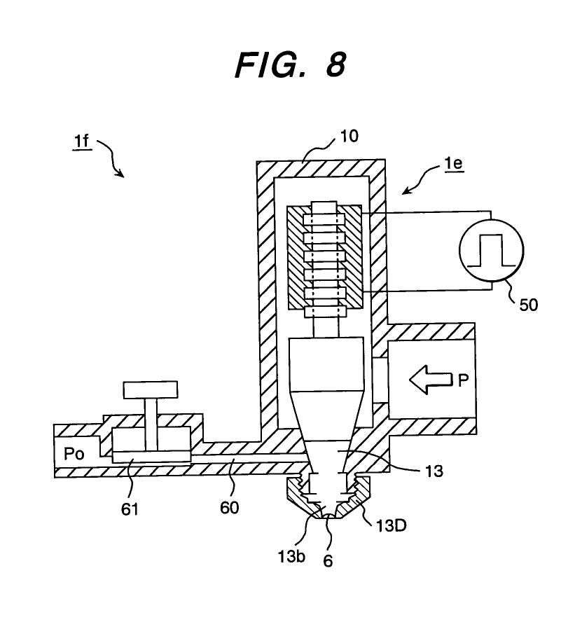

FIG. 8 is a sectional view of a further embodiment of the valve-encased nozzle of the present invention. FIG. 8 shows a sectional view, which employs a countermeasure of the liquid leakage. A pressure regulating conduit 60 communicate with the opening port 13 is disposed so as to generate a negative pressure P₀ at the opening port 13 and at the second opening port 13b.

This conduit 60 has in its intermediate point a break valve 61 that is controllable of its opening degree, and the conduit is communicated by means of a suitable negative pressure-generating source. When the valve is closed, the pressure in the opening port becomes P₀, and the liquid face forms a Meniscus face.

When the valve is opened, the pressure in the valve chamber or the pressure section is transmitted to effect flow of the liquid in the pressure adjusting conduit 60, and when the liquid passes through the break valve 61, resistance is generated by viscosity of the liquid to increase the pressure in the opening port to P, thereby to effect injection of liquid drops. This is a mere example. It is possible to employ any types of the nozzles disclosed mentioned before.

In the embodiment shown in FIG. 8, the conduit 60 and the break valve 61 can be omitted. In this valve encased nozzle, which has no conduit 60 and the break valve 61, the valve-encased nozzle 1e differs from the embodiment shown in FIGS. 1a, 1b and 1c in that (1) an introduction port 12 is formed in the side wall of the casing 10, and an opening port 13D for exchanging itself having a second opening port 13d is disposed at the tip of the opening port 13. The electric magnet 14 is of the stacked type linear motor, and its function is the same as one shown in FIGS. 1a, 1b, and FIG. 1c.

In this embodiment, the exchangeable opening port 13d can have different types such as ones different in size of the second opening 13d, different length of the port 13d, etc. According to this, volumes of liquid drops can be controlled freely. The motion of the valve is controlled by appropriate signals in accordance with the modifications.

In the embodiment mentioned-above, as shown in FIGS. 1a, 1b, 1c, it is preferable to always form Meniscus face as the shape of the liquid face at the opening port 13. The reason is that if a protrudent face is formed at the opening port, leakage of liquid and instable injection may take place. Leakage of liquid not only stains the neighborhood of the opening port, but also alters the direction of injection and injection form.

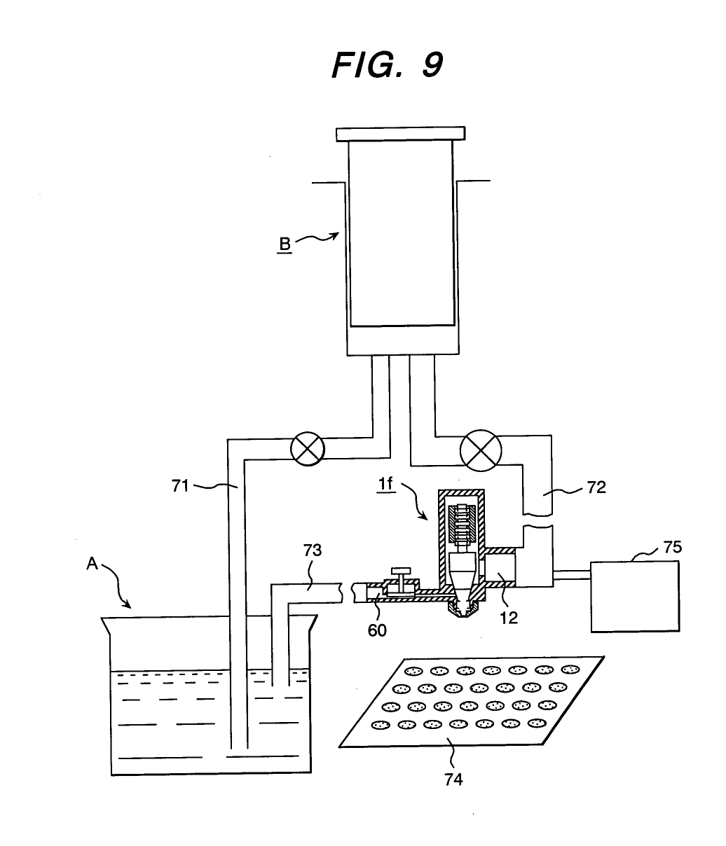

FIG. 9 is an example of a pipetting device that employs the nozzle device 1f of the present invention shown in FIG. 8. A reagent vessel A as a liquid supply section and a syringe B as a pressure section are communicated by means of a conduit 71. The injection side of the syringe B and the introduction port 12 of the valve-encased nozzle 1f are communicated by means of conduit 72, and a pressure adjusting conduit 60 is connected with the reagent vessel A by means of a conduit 73. The nozzle device 1f Is so disposed as to be able to move X-Y directions. The nozzle device is moved by the X-Y actuator 75 to pipette the reagent in the micro-titer plate 74.

In this embodiment, the pressure-adjusting conduit 60 is maintained at a negative pressure P₀ by the position energy. Means for generating a negative pressure P₀ is not limited to the above-mentioned, but any adequate means can be employed. The pressure section is not limited to the syringe.

In the embodiment shown in FIG. 8, another jet port having another pressure control conduit and another break valve can be disposed to the casing 10 to constitute a dual jet type. The valve-encased nozzle can be utilized when a difference between the pressure P of the pressure section and atmosphere or the negative pressure P₀ at the opening port. The basic structure of the valve used in this embodiment is shown in FIG. 5.

The pressure adjusting conduit 60A is disposed at the valve chamber 12 side, and its pressure P₁ is set to one between the pressure P of the pressure section and the negative pressure at the opening port, thereby to prevent liquid leakage and stabilize the liquid surface 6 at the opening port. As a result, reproducible injection of liquid drops can be realized.

In the above-mentioned embodiment, the pressure P of the pressure section is constant, but such variable pressure as shown in FIG. 10 that changes depending on time can be employed. In FIG. 10, the original is the atmospheric pressure, and at each of the pulses, the valve is opened and closed. When the valve is opened and closed in this manner, a load to the valve operation can be made smaller than the constant pressure, and it is possible to produce stable liquid drops.

According to the present invention, it is possible to control error in volume of liquid drops. The liquid to be handled by the nozzle device can have a wide range of viscosity and surface tension, or even non-Newtonian liquid (liquid that changes its volume depending on pressure) can be injected with certainty.

FIG. 11 shows a diagrammatic top plane view of a line head type inkjet head of the present invention. The inkjet head of FIG. 11 employs a plurality of line heads shown in FIG. 7. The inkjet head is controlled by signals given by the nozzle control cable. The head has an ink supply conduit 601 and a nozzle control cable.

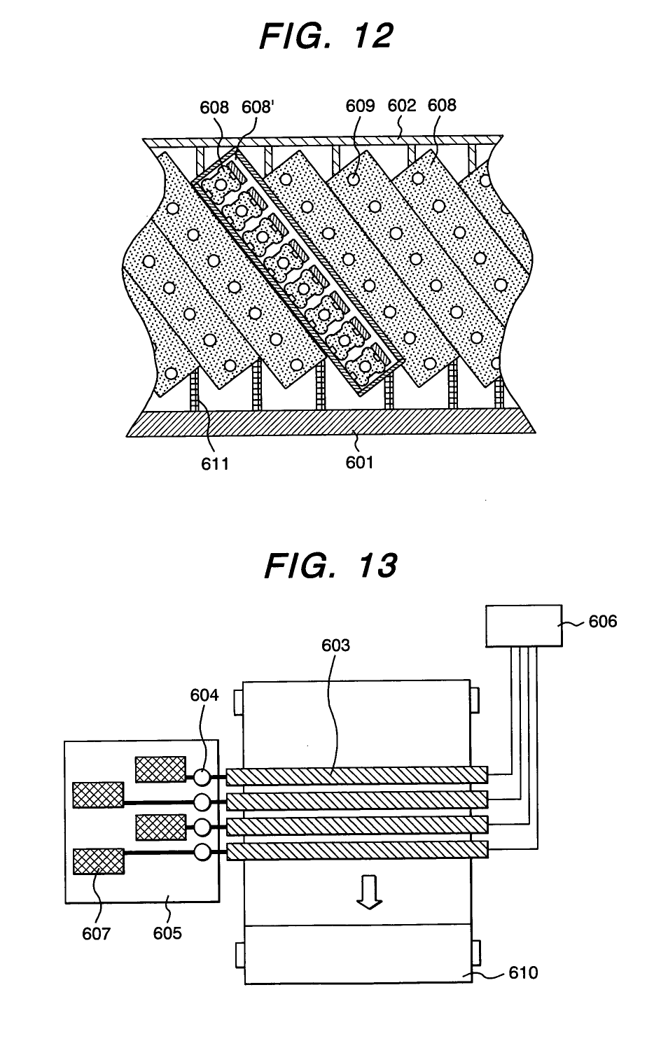

FIG. 12 shows another line type inkjet head, wherein a plurality of nozzle devices is arranged diagonally in parallel so s to increase printing density DPI.

FIG. 13 shows a diagrammatic drawing of an inkjet printer according to the present invention. A printer controller 606 operates a plurality of the line nozzle devices 603. The recording medium such as paper is moved in the direction shown by the arrow. Ink 607 in an ink supply unit 605 is supplied to the line nozzle devices 603 by means of pumps 604. The line printers correspond to the number of colors, that is, cyan, yellow, magenta and black.

Although four line printing nozzles are arranged in FIG. 13, it is possible to increase the number of the line printing nozzles in accordance with the number of colors. It is also possible to dispose a plurality of the units shown in FIG. 13 to increase a printing speed.

According to the present invention, distribution of the drop size or volume can be made minimum; even if the liquid has a wide range of viscosity or surface tension or is a non-Newtonian (volume changes in accordance with pressure), it is possible to jet liquid with accuracy. Therefore, the fundamental requisites, i.e. a constant jetting pressure and discrete and round drops can be met with high reproducibility. For example, liquid having 1 to 500 mPa/sec and a viscosity of 5 to 75 mN/m can stably produce liquid drops having of 5 pico L to 500 μL.

What is claimed is;

1. A valve encased nozzle device comprising a valve chamber having an introduction port for introducing pressurized liquid, and an opening for jetting the liquid, and a valve for closing and opening one or both of the introduction port and the jetting port, wherein the valve is disposed together with a valve driving mechanism in the valve chamber, whereby the introduction port or the injecting port or both are closed or opened by movement of the valve driven by the driving mechanism within the valve chamber.

2. The valve encased nozzle device as defined in claim 1, wherein the valve driving mechanism has a magnetic mechanism for moving the valve.

3. The valve encased nozzle device as defined in claim 1, wherein the valve driving mechanism is a tunnel motor or a linear motor.

4. The valve encased nozzle device as defined in claim 1, wherein the valve driving mechanism has a heater, whereby the valve is driven by bubbles generated by heating with the heater.

5. The valve encased nozzle device as defined in claim 1, wherein the valve and the opening port and/or the introduction port are axial symmetry, and the center lines of them are on the same axial line, whereby the movement of the valve in the center line direction makes the opening port and/or the introduction port opened or closed.

6. The valve encased nozzle device as defined in claim 1, wherein the valve is a slide valve.

7. The valve encased valve as defined in claim 1, wherein the valve functions as a slide valve to the introduction port, and the same valve functions so as to close and open the opening port by the movement in the direction of the center line.

8. The valve encased nozzle device as defined in claim 1, wherein the opening port has a structure that is exchangeable.

9. The valve encased nozzle device as defined in claim 1, further comprising a mechanism for maintaining a predetermined pressure inside of the opening port at the time of closing of the valve.

10. The valve encased nozzle device as defined in claim 1, further comprising a mechanism for maintaining a predetermined pressure in the valve chamber.

11. A nozzle device comprising the valve encased nozzle device as defined in claim 1, which further comprises a liquid supply section and a pressure section for imparting an injection pressure to the liquid.

12. The nozzle device as defined in claim 11, which further comprises a pressure source connected to a mechanism for maintaining a predetermined pressure at the opening port of the valve encased nozzle device.

13. The nozzle device as defined in claim 11, which further comprises a pressure source connected to a mechanism for maintaining a predetermined pressure in the valve chamber of the valve encased nozzle device.

14. The nozzle device as defined in claim 11, wherein a pressure generated by the pressure source is one of a pressure selected from the group consisting of a constant pressure, a pulsating pressure and a pressure that changes depending on time.

15. A liquid handling device, which comprises a nozzle device comprising a valve chamber having a liquid introduction port, which is connectable to a liquid source, and a liquid jetting port, a valve, confined in the valve chamber, for closing and opening the introduction port and/or the jetting port, and a valve driving mechanism, confined in the valve chamber, wherein the valve and the valve driving mechanism complete their functions in the valve chamber.

16. An inkjet head, which comprises an array of nozzle devices each comprising a valve chamber having an ink introduction port and a nozzle for an ink jetting port, a valve, confined in the valve chamber, and a valve driving mechanism, confined in the valve chamber, for driving the valve, wherein the valve and the valve driving mechanism are liquid tightly sealed in the valve chamber and the valve and the valve driving mechanism perform their functions only in the valve chamber.

17. An inkjet printer, which comprises an array of nozzle devices each comprising a valve chamber having a liquid introduction port, which is connectable to a liquid source, and a liquid jetting port, a valve, confined in the valve chamber, for closing and opening the introduction port and/or the jetting port, and a valve driving mechanism, confined in the valve chamber, wherein the valve and the valve driving mechanism complete their functions in the valve chamber.

18. An inkjet head, which comprises an inkjet head comprising an array of nozzle devices, wherein each of the nozzle devices comprises a valve chamber having an ink introduction port and a nozzle for an ink jetting port, a valve, confined in the valve chamber, and a valve driving mechanism, confined in the valve chamber, for driving the valve, wherein the valve and the valve driving, mechanism are liquid tightly sealed in the valve chamber and the valve and the valve driving mechanism perform their functions only in the valve chamber; a controller for controlling the inkjet head; and a recording medium transfer mechanism.

19. A micro-pipetting device for supplying liquid in a micro amount, which comprises a micro-titer plate for receiving liquid samples and a nozzle device, wherein the nozzle device comprises a valve chamber having a liquid introduction port and a liquid jetting port, a valve for closing and opening the introduction port and the jetting port, and a valve driving mechanism, the vale and the valve driving mechanism being confined within the valve chamber.
